(19) United States
(12) Patent Application Publication
(10) Pub. No.: US 2006/0227304 A1
(43) Pub. Date: Oct. 12, 2006

(54) Optical assembly for a projection system

(75) Inventors: Byung-jo Kang, Suwon-si (KR); Jeong-ho Nho, Suwon-si (KR); Jong-hak Moon, Hwaseong-gun (KR); Sung-je Woo, Suwon-si (KR); Kyoung-choul Jang, Suwon-si (KR); Heong-seog Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/358,416

(22) Filed: Feb. 22, 2006

(30) Foreign Application Priority Data
Apr. 6, 2005 (KR) 2005-28349

(51) Int. Cl. G03B 21/22

(52) U.S. Cl. 353/119

(57) ABSTRACT

An optical assembly for a projection system includes a light tunnel, a light tunnel holder that supports the light tunnel, an exterior casing that supports the light tunnel holder, a resilient member disposed between the light tunnel holder and the exterior casing to resiliently support the light tunnel holder, and an aligning unit that is disposed opposite the resilient member to align the light tunnel. The aligning unit can have at least one holder protrusion formed on an outer surface of the light tunnel holder, and a movable member that has a pressing protrusion for contact with the holder protrusion. The movable member slides on the outside of the light tunnel holder.

### CROSS-REFERENCE TO RELATED APPLICATIONS

This application claims the benefit under 35 U.S.C. § 119(a) of Korean Patent Application No. 2005-28349, filed Apr. 6, 2005, the entire contents of which are hereby incorporated by reference.

### BACKGROUND OF THE INVENTION

1. Field of the Invention

The present invention relates to a projection system. More particularly, the present invention relates to an optical assembly for a projection system with an improved apparatus for aligning a light tunnel that converts light projected from a light source into a uniform light.

2. Description of the Related Art

In a conventional projection system, an image is formed by controlling light projected from a light source by turning on and off pixels in a light valve (which is a display device). The image is provided to a wide screen using an extended projection optical system.

Recently, a digital light processing (DLP) projection system has been developed. A DLP projection systems uses a DLP panel that is fabricated by micro electro mechanic system (MEMS) technology as a reflective display device.

The DLP panel for image formation, used in the projection system, comprises a plurality of micromirrors that are arranged on a substantially flat plane. Each micromirror corresponds to a pixel. A reflection angle of incident light is changed by independently driving each of the micromirrors according to image signals. Accordingly, the light can be turned on and off to generate an image.

FIG. 1 is a schematic perspective view of the structure of a conventional projection system. Referring to FIG. 1, a white light is generated by a light source 102 and passes through a color wheel 103. The color wheel sequentially splits the white light into three lights, that is, red (R), green (G), and blue (B) lights. The split lights are passed through a light tunnel 151 that constitutes an optical assembly 150. Light entering the light tunnel is reflected inside the light tunnel multiple times to produce a uniform light. The uniform light generated by the light tunnel 151 passes through an optical path conversion unit 115 and enter a total reflection prism 135 that is tilted by approximately 45°. The optical path conversion unit 115 comprises a first reflection mirror 108 for reflecting the light passed through the light tunnel 151, a first lens 112 for focusing the light reflected from the first reflection mirror 108, a second reflection mirror 114 for bending the optical path of the light passed through the first lens 112 toward the total reflection prism 135, and a second lens 117 for focusing the light reflected from the second reflection mirror 114 on the total reflection prism 135. The light incident on the total reflection prism 135 is irradiated on a DLP panel 130. The respective pixels of the DLP panel are driven to tilt them approximately 45° to produce an almost perfect reflection condition and generate an image. The irradiated light is image-modulated and projected onto a screen (not shown) at an enlarged size through a projection lens 140.

FIG. 2 is a perspective view of the structure of a conventional optical assembly. Referring to FIG. 2, the optical assembly 150 comprises first and second casings 151a and 151b that are shaped symmetrically with each other. In the first and the second casings 151a and 151b, a light tunnel holder 153 is inserted to support the light tunnel 151 (FIG. 5), which will be described in further detail later. Fastening screws 159a and 159b are used to align the light tunnel 151, as will be described in further detail later.

FIG. 3 illustrates the conventional optical assembly with the first casing 151a removed, and FIG. 4 illustrates the conventional optical assembly with the light tunnel holder 153 removed. Referring to FIGS. 3 and 4, a resilient member 155 for resiliently supporting the light tunnel holder 153 is mounted in the second casing 151b. The resilient member 155 is formed of metal and includes resilient protrusions 155a and 155b that contact an outer surface of the light tunnel holder 153. The light tunnel holder 153 is placed on the resilient member 155, and then the second casing 151b is engaged with the first casing 151a, as shown in FIG. 2.

FIG. 5 is a sectional view cut along the line II-II in FIG. 2, for showing the operation of aligning the light tunnel. Referring to FIG. 5, the light tunnel 151 comprises four walls arranged at 90° with respect to one another, and is mounted in the light tunnel holder 153. The light tunnel 151 converts incident light into uniform light and shapes the beam. The outer surface of the light tunnel holder 153 is resiliently supported by the resilient protrusions 155a and 155b of the resilient member 155. To align the light tunnel 151 with an optical axis C, the first and the second casings 151a and 151b are provided with fastening parts 151c and 151d that engage the fastening screws 159a and 159b. The fastening screws 159a and 159b face the resilient protrusions 155a and 155b. Therefore, as the fastening screws 159a and 159b are engaged, each end of the fastening screws 159a and 159b presses the outer surface 153 of the light tunnel holder 153 in the direction indicated by the arrows A, thereby aligning the light tunnel 151 with the optical axis C.

Aligning the light tunnel 151 using the fastening screws 159a and 159b is cumbersome.

Accordingly, there is a need for an improved optical assembly for a projection apparatus that allows easier alignment of a light tunnel in the optical assembly.

### SUMMARY OF THE INVENTION

An aspect of the present invention is to address at least the above problems and/or disadvantages and to provide at least the advantages described below. Accordingly, an aspect of the present invention is to provide an optical assembly for a projection system that has an improved aligning unit for a light tunnel so as to align the light tunnel more easily.

In accordance with an aspect of the invention, an optical assembly for a projection system comprises a light tunnel, a light tunnel holder that supports the light tunnel, an exterior casing that supports the light tunnel holder, a resilient member that is disposed between the light tunnel holder and the exterior casing to resiliently support the light tunnel holder; and an aligning unit disposed in the face of the resilient member to align the light tunnel.

The aligning unit may comprise at least one holder protrusion formed on an outer surface of the light tunnel holder, and a movable member sliding on the outside of the light tunnel holder. The movable member has a pressing protrusion to contact the holder protrusion.

The movable member may be disposed between the light tunnel holder and the exterior casing. The movable member may have a protruding operation lever. The exterior casing has a guide hole for the operation lever to penetrate and slide through.

One end of the operation lever may be connected with a lever cap through a fixing member.

The fixing member may comprise a hook protruding from a surface of the operation lever and a hook recess formed at the lever cap to be engaged with the hook.

The movable member may further comprise a position holding unit at one side to fix the position of the pressing protrusion and the holder protrusion into contact with each other.

The position holding unit may comprises a fastening piece formed at one side of the movable member and having a via-hole; and a position holding screw penetrating the via-hole. The exterior casing has a screw guide hole that penetrates the position holding screw.

The holder protrusion and the pressing protrusion may have curved surfaces.

According to the above-structured optical assembly for a projection system, the light tunnel can be more easily aligned, thereby improving productivity.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a schematic, perspective view of the structure of a conventional projection system;

FIG. 2 is a perspective view of the structure of the conventional optical assembly;

FIG. 3 is a perspective view of the structure of the conventional optical assembly shown in FIG. 2, with the first casing removed;

FIG. 4 is a perspective view of the structure of the conventional optical assembly shown in FIG. 2, with the first casing and the light tunnel holder removed;

FIG. 5 is a sectional view along line II-II of FIG. 2, for explaining the operation for aligning the light tunnel;

FIG. 6 is a schematic, perspective view of the structure of an optical engine of a projection system according to an exemplary embodiment of the present invention;

FIG. 7 is an enlarged, perspective view of the structure of the optical assembly of FIG. 6;

FIG. 8 is a partially exploded, perspective view of the optical assembly of FIG. 7, without a first casing;

FIG. 9 is a partially exploded, perspective view of the optical assembly of FIG. 7, without a light tunnel holder;

FIG. 10 is a sectional view along line VII-VII in FIG. 7; and

FIG. 11 is a perspective view of the structure of the optical assembly according to an exemplary embodiment of the present invention.

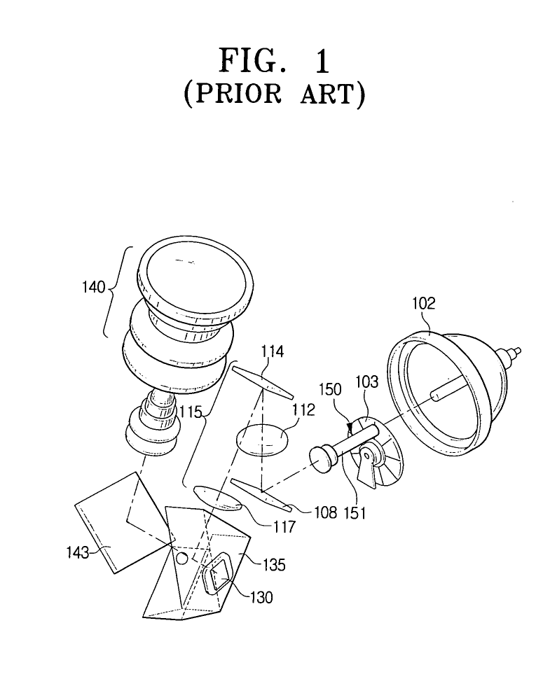

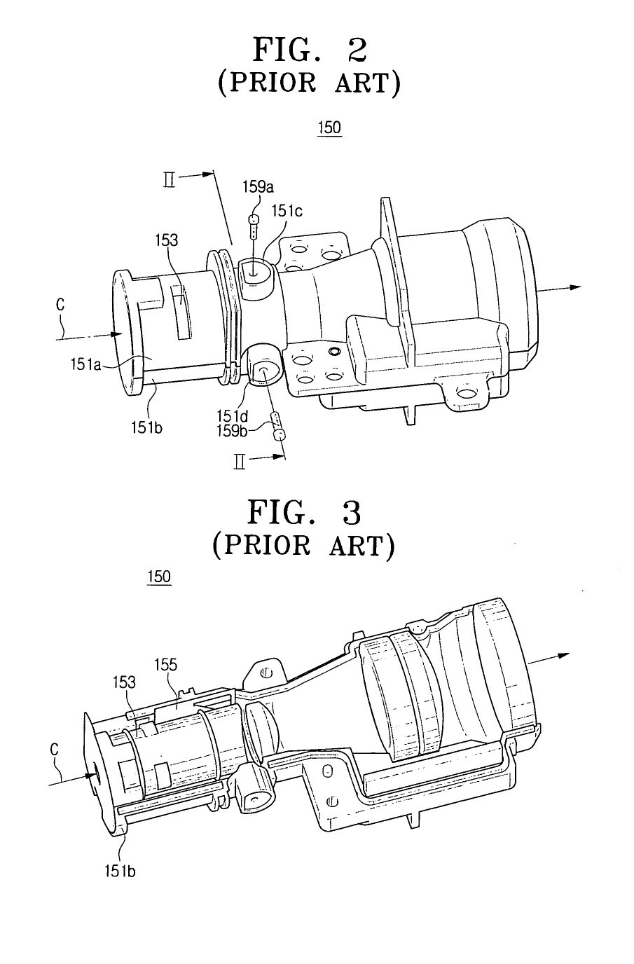

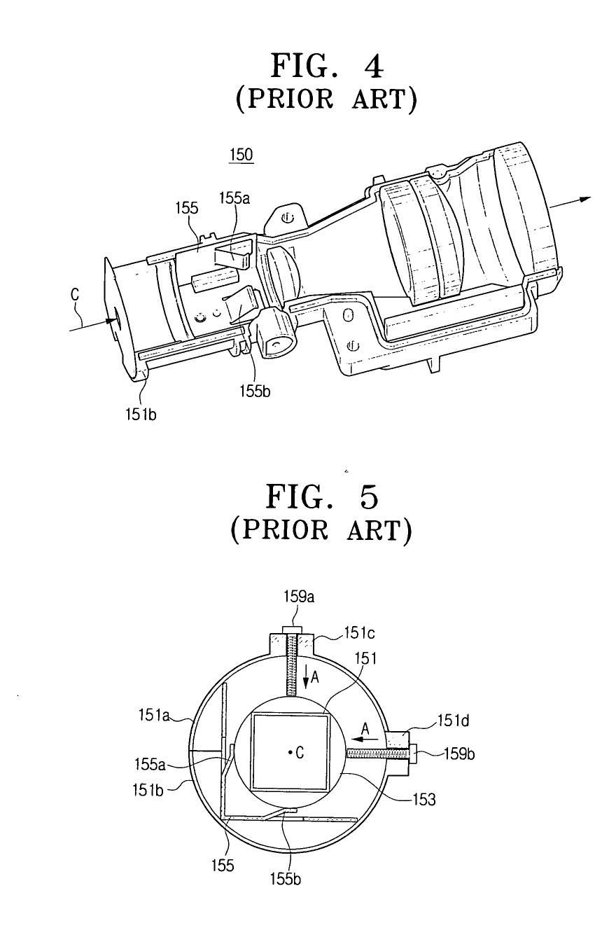

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

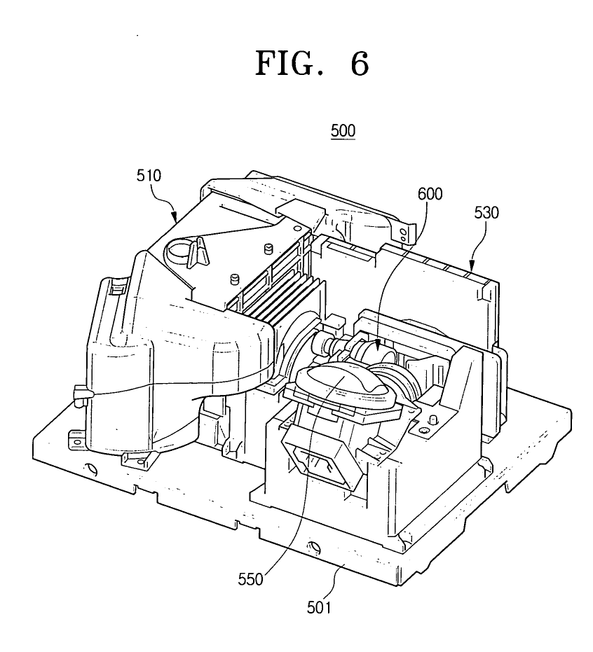

FIG. 6 is a perspective view that schematically illustrates the structure of an optical engine of a projection system. Referring to FIG. 6, an optical engine 500 comprises a base 501, a lighting part 510, an optical assembly 600, a digital micro-mirror device (DMD) assembly 530, and a projection lens part 550. According to the above structure, light irradiated from the lighting part 510 is converted to a uniform light by passing through the optical assembly 600 and is irradiated on the DMD assembly 530. The irradiated light is reflected toward the projection lens part 550, and an image light reflected to the projection lens part 550 is projected onto a projection surface, such as a screen (not shown).

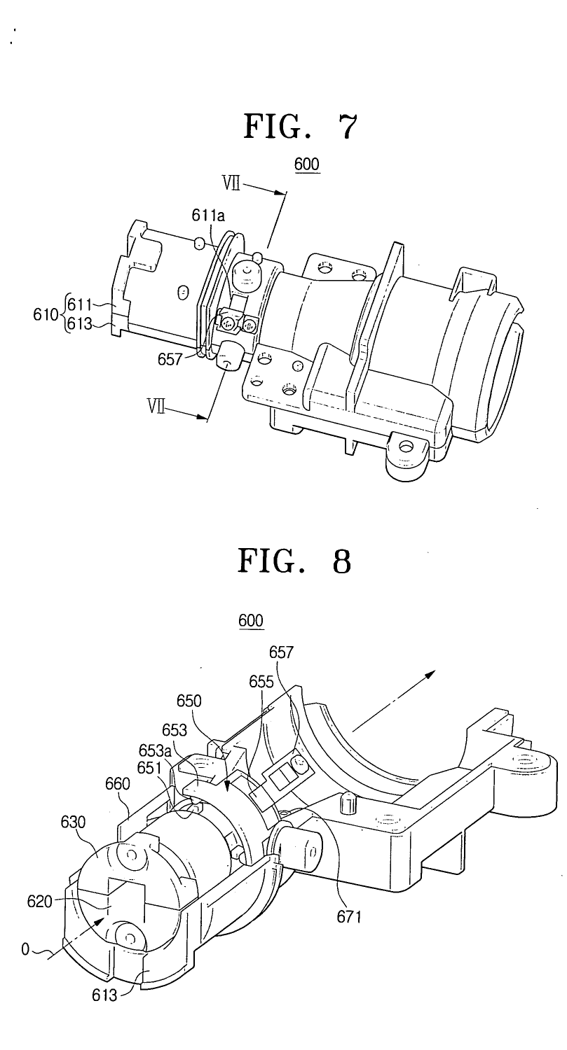

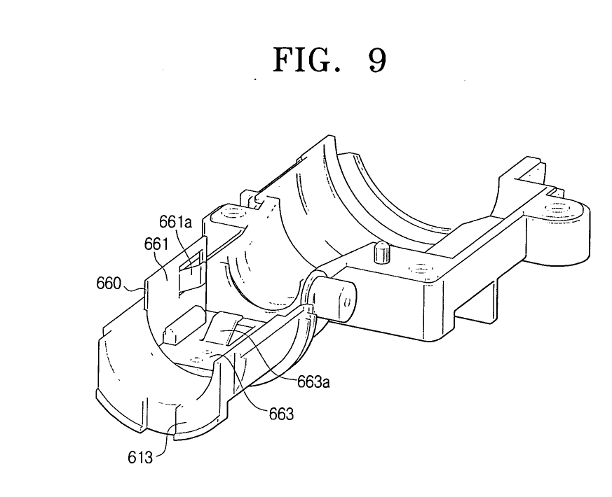

FIG. 7 is an enlarged perspective view of FIG. 6, FIG. 8 is a partially exploded, perspective view of FIG. 7 with a first casing removed, and FIG. 9 is a partially exploded, perspective view of FIG. 7 with a light tunnel holder removed.

Referring to FIG. 7, the optical assembly 600 includes an exterior casing 610 comprising first and second casings 611 and 613 having a substantially symmetrical shape with each other.

Referring to FIG. 8, the second casing 613 mounts a light tunnel holder 630 that supports a light tunnel 620. The light tunnel 620 is formed by four walls arranged at substantially right angles (90°) with respect to one another so that the light projected from the lighting part 510 (FIG. 6) is reflected multiple times and formed into a uniform beam. Since the light tunnel 620 is required to be aligned on an optical axis O of the light incident on the lighting part 510, an aligning unit 650 for conveniently setting the alignment of the light tunnel 620 is provided by the present invention. The aligning unit 650 will be described in further detail below.

Referring to FIG. 9, a resilient member 660 is mounted in the second casing 613 to resiliently support the light tunnel holder 630 (FIG. 8). The resilient member 660 is configured in a manner that metal pieces are bent by a predetermined angle and resilient protrusions 661a and 663a are formed on the bent surfaces 661 and 663, respectively, for resilient contact with an outer surface of the light tunnel holder 630.

The structure of the aligning unit 650 will now be described in greater detail.

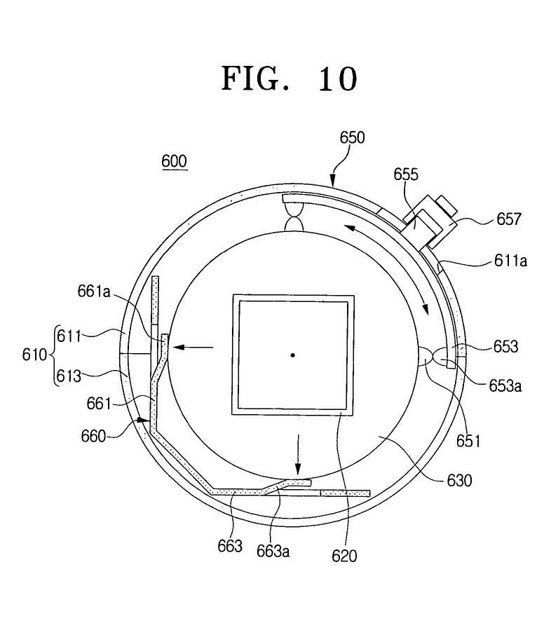

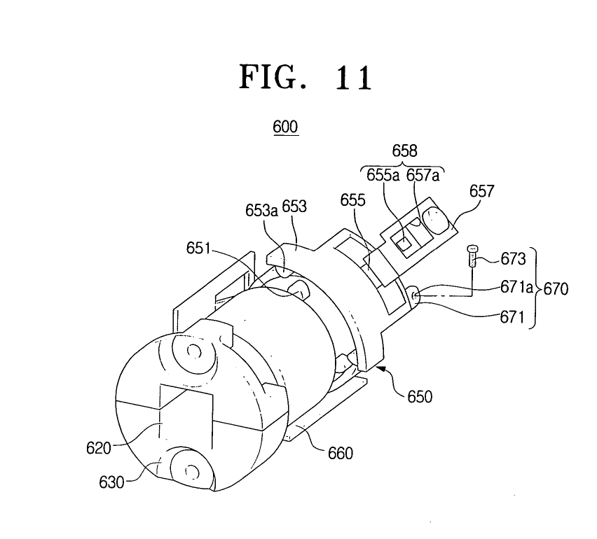

FIG. 10 is a sectional view along line VII-VII in FIG. 7, and FIG. 11 is a perspective view showing a part of the optical assembly according to an exemplary embodiment of the present invention.

Referring to FIG. 10, the light tunnel holder 630 is mounted in the second casing 613 that forms the exterior casing 610. The resilient member 660 is disposed between the light tunnel holder 630 and the second casing 613. Therefore, the resilient protrusions 661a and 663a of the resilient member 660 contact and resiliently press the outer surface of the light tunnel holder 630. The aligning unit 650 to set the alignment of the light tunnel 620 is disposed on the other side of the outer surface of the light tunnel holder 630, opposite to the resilient member 660.

The aligning unit 650 comprises at least one holder protrusion 651 formed on the outer surface of the light tunnel holder 630, a pressing protrusion 653a corresponding to the holder protrusion 651, and a movable member 653 on the outside of the light tunnel holder 630. The movable member 653 is formed as an arc corresponding to the outer surface of the light tunnel holder 630 and is slidably disposed between the first casing 611 and the light tunnel holder 630. The holder protrusion 651 and the pressing protrusion 653a preferably have curved surfaces for smooth contact with each other.

An operation lever 655 is formed on the movable member 653 and protrudes outside the first casing 611. The first casing 611 is provided with a guide hole 611a (FIG. 7) to allow manipulation of the operation lever 65.

Referring to FIG. 11, a lever cap 657 is connected to an end of the operation lever 655 by a fixing member 658 to allow a user to conveniently grab the operation lever 655. The fixing member 658 comprises a hook 655a that protrudes from a surface of the operation lever 655 and a hook recess 657a formed on the lever cap 657 to be engaged with the hook 655a.

The movable member 653 is moved in an appropriate direction so that the pressing protrusion 653a and the holder protrusion 651 come into contact with each other. A position holding unit 670 is provided to fix the contact position of the protrusions 653a and 651. The position holding unit 670 comprises a fastening piece 671 formed at one side of the movable member 653. The fastening piece 671 has a via-hole 671a, and a position holding screw 673 penetrates the via-hole 671a. Preferably, the first casing 611 forming the exterior casing 610 is provided with a hole (not shown) corresponding to a sliding range of the via-hole 67a, formed in a similar manner to the guide hole 611a.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An optical assembly for a projection system, comprising:
a light tunnel;
a light tunnel holder that supports the light tunnel;
an exterior casing that supports the light tunnel holder;
a resilient member disposed between the light tunnel holder and the exterior casing to resiliently support the light tunnel holder; and
an aligning unit disposed in the exterior casing opposite the resilient member to align the light tunnel.

2. The optical assembly of claim 1, wherein the aligning unit comprises:
at least one holder protrusion formed on an outer surface of the light tunnel holder; and
a movable member having a pressing protrusion to contact the holder protrusion, the movable member moving on the outside of the light tunnel holder.

3. The optical assembly of claim 2, wherein
the movable member is disposed between the light tunnel holder and the exterior casing.

4. The optical assembly of claim 3, wherein
the movable member has an operation lever.

5. The optical assembly of claim 4, wherein
the exterior casing has a guide hole for the operation lever to penetrate through and move in.

6. The optical assembly of claim 4, wherein
one end of the operation lever is connected with a lever cap by a fixing member.

7. The optical assembly of claim 6, wherein the fixing member comprises:
a hook protruding from a surface of the operation lever; and
a hook recess formed at the lever cap for to be engaged with the hook.

8. The optical assembly of claim 2, wherein the movable member further comprises
a position holding unit at one side of the movable member to fix a position of the pressing protrusion and the holder protrusion into contact with each other.

9. The optical assembly of claim 8, wherein the position holding unit comprises:
a fastening piece formed at one side of the movable member and having a via-hole; and
a position holding screw penetrating the via-hole.

10. The optical assembly of claim 9, wherein
the exterior casing has a screw guide hole to allow the position holding screw to penetrate through the exterior casing.

11. The optical assembly of claim 2, wherein
the holder protrusion and the pressing protrusion have curved surfaces.

12. An optical assembly for a projection system, comprising:
a light tunnel;
a light tunnel holder that supports the light tunnel, the light tunnel holder having at least one holder protrusion formed on an outer surface of the light tunnel holder;
an exterior casing that supports the light tunnel holder;
a resilient member disposed between the light tunnel holder and the exterior casing to resiliently support the light tunnel holder; and
a movable member movably disposed between the light tunnel holder and the exterior casing, the movable member having a pressing protrusion to contact the holder protrusion.

13. The optical assembly of claim 12, wherein
the movable member has an operation lever.

14. The optical assembly of claim 13, wherein
the exterior casing has a guide hole for the operation lever to penetrate through and move in.

15. The optical assembly of claim 14, wherein
one end of the operation lever is connected with a lever cap by a fixing member.

16. The optical assembly of claim 15, wherein the fixing member comprises:
a hook protruding from a surface of the operation lever; and
a hook recess formed at the lever cap for to be engaged with the hook.

17. The optical assembly of claim 12, wherein the movable member further comprises
a position holding unit at one side of the movable member to fix a position of the pressing protrusion and the holder protrusion into contact with each other.

18. The optical assembly of claim 17, wherein the position holding unit comprises:
a fastening piece formed at one side of the movable member and having a via-hole; and
a position holding screw penetrating the via-hole.

19. The optical assembly of claim 18, wherein
the exterior casing has a screw guide hole to allow the position holding screw to penetrate through the exterior casing.

20. The optical assembly of claim 12, wherein
the holder protrusion and the pressing protrusion have curved surfaces.
